(19) United States
(12) Patent Application Publication
(10) Pub. No.: US 2015/0142550 A1
(43) Pub. Date: May 21, 2015

(54) SYSTEMS AND METHODS FOR AGGREGATING CONSUMER ACTIVITY IN A REWARDS PROGRAM

(71) Applicant: MasterCard International Incorporated, Purchase, NY (US)

(72) Inventors: Trevor S. Owen, O'Fallon, MO (US); Brooke Beeson, St. Charles, MO (US); Rachel Kuenzler, Eureka, MO (US)

(73) Assignee: MasterCard International Incorporated, Purchase, NY (US)

(21) Appl. No.: 14/086,107

(22) Filed: Nov. 21, 2013

(51) Int. Cl. G06Q 30/02

(52) U.S. Cl. CPC G06Q 30/0226; G06Q 30/0236
USPC 705/14.27

(57) ABSTRACT

A computer-implemented method for aggregating consumer activity in a loyalty reward program is described. The method implemented using a computing device in communication with a memory. The method includes storing, in the memory, at least one reward offer containing a reward and an activity threshold, receiving registration data from a plurality of registered consumers for the at least one reward offer, storing, in the memory, the registration data for each of the plurality of registered consumers, monitoring financial transaction data for at least one qualifying activity completed by at least one of the plurality of registered consumers, compiling, by the computing device, a total number of qualifying activities completed by all of the registered consumers, and sending the reward to each of the registered consumers when the activity threshold is reached by the total number of qualifying activities.

### BACKGROUND

The field of the disclosure relates generally to a rewards program, and more particularly to aggregating consumer activity for measuring consumer participation in a rewards program in which a reward is earned through compiling activity from multiple consumers to reach a threshold level.

Rewards programs are generally set-up to reward consumer loyalty. For example, a consumer may fly with a certain airline for a certain number of times and receive a free flight. That is, the consumer earns rewards or reward points by simply making use of the associated company or services. In some rewards programs, the consumer is able to choose a reward from a selection of rewards. In other rewards programs, a gift certificate is sent to the consumer after a predetermined number of transactions. In some other rewards programs, payment card companies send inserts for offers along with a monthly bill. Many of these inserts are not applicable to the consumer that receives them. Accordingly, it would be beneficial to make the consumer more of a part of the rewards process to not only drive consumers to use the company or service more, but also to improve the consumer's experience with the company or service and engender more loyalty.

### BRIEF DESCRIPTION OF THE DISCLOSURE

In one aspect, a computer-implemented method for aggregating consumer activity in a loyalty reward program is described. The method is implemented using a computing device in communication with a memory. The method includes storing in the memory at least one reward offer containing a reward and an activity threshold, receiving registration data from a plurality of registered consumers for the at least one reward offer, storing in the memory the registration data for each of the plurality of registered consumers, monitoring financial transaction data for at least one qualifying activity completed by at least one of the plurality of registered consumers, compiling by the computing device a total number of qualifying activities completed by all of the registered consumers, and sending the reward to each of the registered consumers when the activity threshold is reached by the total number of qualifying activities.

In another aspect, a computing device for aggregating consumer activity in a loyalty reward program is described. The computing device includes a processor communicatively coupled to a memory device. The computing device is configured to store at least one reward offer containing a reward and an activity threshold, receive registration data from a plurality of registered consumers for the at least one reward offer, store the registration data for each of the plurality of registered consumers, monitor financial transaction data for at least one qualifying activity completed by at least one of the plurality of registered consumers, compile a total number of qualifying activities completed by all of the registered consumers, and send the reward to each of the registered consumers when the activity threshold is reached by the total number of qualifying activities.

In yet another aspect, a computer-readable storage medium having computer-executable instructions embodied thereon is described. When executed by a computing device having at least one processor coupled to a memory device, the computer-executable instructions cause the processor to store at least one reward offer containing a reward and an activity threshold. The computer-executable instructions also cause the processor to receive registration data from a plurality of registered consumers for the at least one reward offer, store the registration data for each of the plurality of registered consumers, monitor financial transaction data at least one qualifying activity completed by at least one of the plurality of registered consumers, compile a total number of qualifying activities completed by all of the registered consumers, and send the reward to each of the registered consumers when the activity threshold is reached by the total number of qualifying activities.

### BRIEF DESCRIPTION OF THE DRAWINGS

FIGS. 1-9 show example embodiments of the methods and systems described herein.

FIG. 1 is a schematic diagram illustrating an example multi-party payment card industry system for enabling ordinary payment-by-card transactions in which merchants and card issuer processors do not necessarily have a one-to-one relationship.

FIG. 2 is a simplified block diagram of an example aggregate rewards program system that includes an aggregate rewards program (ARP) computing device for aggregating consumer activity in a rewards program in accordance with one embodiment of the present disclosure.

FIG. 3 illustrates an example configuration of a client system shown in FIG. 2, in accordance with one embodiment of the present disclosure.

FIG. 4 illustrates an example configuration of the server system shown in FIG. 2, in accordance with one embodiment of the present disclosure.

FIG. 5 is a block diagram illustrating an example of a rewards program 500 registering a consumer, monitoring a consumer's activity, and sending rewards to a consumer using the ARP computing device (shown in FIG. 2).

FIG. 6 is a diagram of an example user interface for enabling a consumer to select a reward offer from a plurality of reward offers and displaying the status of reward offers, in accordance with one embodiment of the present disclosure.

FIG. 7 is a flowchart illustrating an example of the process of aggregating consumer activity in a rewards program using the system shown in FIG. 2, in accordance with one embodiment of the present disclosure.

FIG. 8 is a diagram of the components of an example database included in the system show in FIG. 2, in accordance with one embodiment of the present disclosure.

FIG. 9 is an example configuration of the ARP computing device within the aggregate rewards program system shown in FIG. 2, in accordance with one embodiment of the present disclosure.

### DETAILED DESCRIPTION OF THE DISCLOSURE

The following detailed description illustrates embodiments of the disclosure by way of example and not by way of limitation. It is contemplated that the disclosure has general application to managing a consumer rewards program.

The systems and methods described herein relate to managing a consumer rewards program. More specifically, the systems and methods described herein are configured to aggregate consumer activity for measuring consumer participation in a rewards program in which a reward is earned through compiling activity from multiple consumers that reach a threshold level.

In the example embodiment, an aggregate rewards program (ARP) computing device is configured to cause a website to be displayed on a remote client device. The website, which is associated with a rewards program for a payment card, displays a reward offer to a plurality of consumers. The reward offer contains a basic reward, an enhanced award, and an achievement reward. The website enables the consumers to register for the reward offer. The website receives registration data from the consumer and sends the registration data to the ARP computing device. The registration data may contain one or more of the consumer's name, e-mail address, screen name, screen name, reward offer selected, and a unique identifier for the consumer such as a payment card number. In the example embodiment, each consumer may only register for one reward offer at a time.

When a registered consumer threshold is reached, the ARP computing device activates the reward offer. The ARP computing device, which is in communication with a payment processing network, monitors the activities of all of the registered consumers. The ARP computing device transmits a list of the registered consumers for the reward offer to the payment processing network. The payment processing network transmits the activities of the registered consumers to the ARP computing device. In the example embodiment, the activities that the ARP computing device monitors are the transactions for purchases that each registered consumer initiates with a payment card associated with the rewards program. The ARP computing device counts each qualifying activity. While in this specific embodiment qualifying activities are transactions that exceed a minimum dollar amount (sometimes referred to as qualifying transactions), qualifying activities may, for example, also be purchases at a specific merchant or merchant category (e.g., restaurants), purchases transacted during a predetermined time period, purchases of specific items, or purchases of specific combinations of different items. When the total amount of qualifying activities performed by the registered consumers exceeds an activity threshold for the reward offer, then the ARP computing device sends a reward or rewards to the registered consumers. In this embodiment, the activity threshold is the total amount of transactions required to complete the reward offer.

In the example embodiment, the reward or rewards may be sent to the registered consumers in the form of a redemption code, which may be scanned at a register or entered into a website to redeem the reward. In the example embodiment, the ARP computing device may send the reward to the registered consumers through e-mail. In other embodiments, ARP computing device may send the reward through an electronic message, a text message, or Short Message Service (SMS), an app to display the redemption code, or the ARP computing device may enable a physical mailing to be sent to the registered consumers.

The ARP computing device sends an e-mail containing the redemption code for the basic reward to each registered consumer that had a minimum amount of qualifying activities. The ARP computing device is also configured to randomly select a number of registered consumers, and then send a redemption code for the enhanced reward via e-mail to those registered consumers. The ARP computing device is also configured to send a redemption code for the achievement award to the registered consumer or consumers with the most qualifying activities while the reward was active, where the most qualifying activities, for example, may be the most transactions or the largest total dollar amount spent over all of the transactions. Once the rewards are sent, the reward offer is finished and the consumers may register for other reward offers.

In another embodiment, the reward offer is linked to a charity organization. For every qualifying activity, the ARP computing device makes a donation to the charity organization. This charity organization can be one selected by the reward offer or by the consumer at registration and stored in the registration data.

The methods and systems described herein may be implemented using computer programming or engineering techniques including computer software, firmware, hardware, or any combination or subset wherein a technical effect of the systems and processes described herein is achieved by performing at least one of the following steps: (a) providing an aggregated rewards program (ARP) computing device in communication with a memory and in communication with a payment processing system; (b) storing, in the memory, at least one reward offer containing a basic reward and an activity threshold; (c) receiving registration data from a plurality of registered consumers for one of the at least one reward offer; (d) storing, in the memory, the registration data for each of the plurality of registered consumers, wherein the registration data may include the registered consumer's name, e-mail address, screen name, chosen charitable organization, and a unique identifier such as a payment card number; (e) activating the reward offer when a registered consumer threshold (i.e. number of registered consumers, etc.) is reached; (f) monitoring at least one qualifying activity completed by at least one of the plurality of registered consumers; (g) compiling, by the aggregate rewards program computing device, a total number of qualifying activities completed by all of the registered consumers; (h) sending a donation to the charitable organization for each qualifying activity; (i) sending, via e-mail, a redemption code for the basic reward to each of the registered consumers who has a minimum amount of qualifying activities when the activity threshold is reached by the total number of qualifying activities; (j) sending, via e-mail, a redemption code for an enhanced reward to a certain number of randomly selected registered consumers; and (k) sending, via e-mail, a redemption code for an achievement reward to the registered consumer with the most qualifying activities.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The term rewards program, as used herein, may refer to a rewards program associated with payment cards, hotel stays, airline flights, car rentals, websites visited, gaming, and any other item capable of generating rewards. The examples are not limiting as to the items that a rewards program may be associated with.

The term activity, as used herein, may refer to payment card transactions, hotel night stays, dollars spent, trips taken, miles driven, days of car rental, website clicks, donations given, dollars wagered, and any other activity measured. The examples are not limiting as to the activities that may be measured.

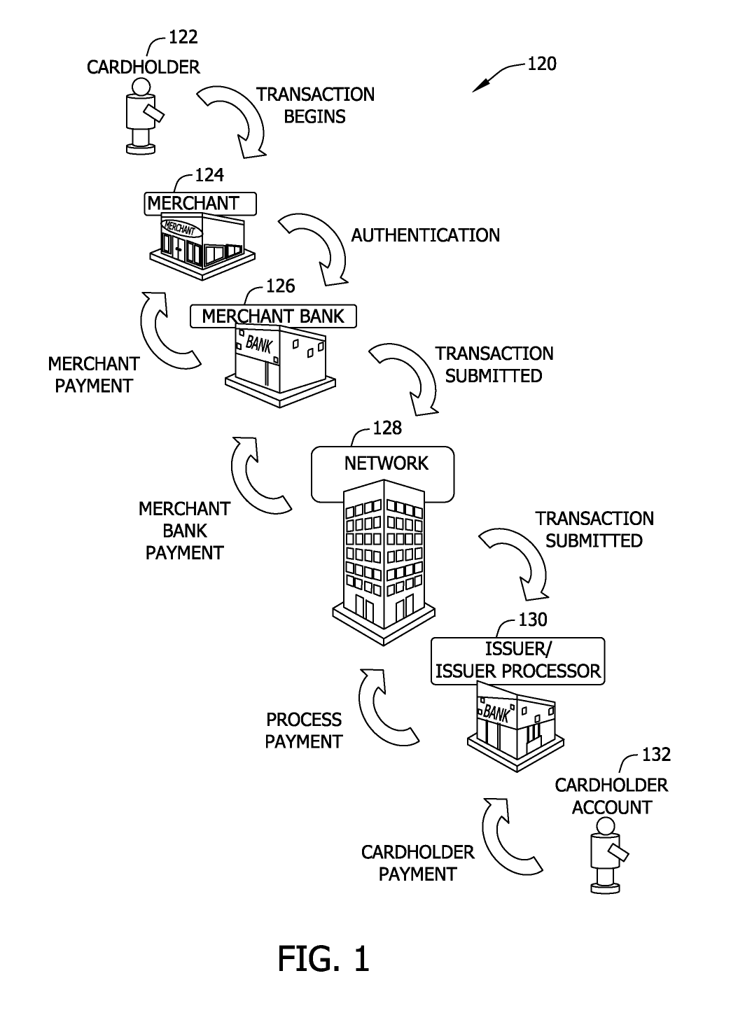

FIG. 1 is a schematic diagram illustrating an example multi-party payment card system 120 for enabling ordinary payment-by-card transactions in which merchants and card issuer processors do not necessarily have a one-to-one relationship. The present disclosure relates to payment card system 120, such as a credit card payment system using the MasterCard® payment card system payment network 128 (also referred to as an “interchange” or “interchange network”). MasterCard® payment card system payment network 128 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 120, a financial institution such as an issuer issues a payment account card, such as a credit card account or a debit card account, to a cardholder 122, who uses the payment account card to tender payment for a purchase from a merchant 124. To accept payment with the payment account card, merchant 124 must normally establish an account with a financial institution that is part of the financial payment system. This financial institution is usually called the “merchant bank” or the “acquiring bank” or “acquirer bank” or simply “acquirer”. When a cardholder 122 tenders payment for a purchase with a payment account card (also known as a financial transaction card), merchant 124 requests authorization from acquirer 126 for the amount of the purchase. The request may be performed over the telephone, but is usually performed through the use of a point-of-interaction terminal, which reads the cardholder's account information from the magnetic stripe on the payment account card and communicates electronically with the transaction processing computers of acquirer 126. Alternatively, acquirer 126 may authorize a third party to perform transaction processing on its behalf. In this case, the point-of-interaction terminal will be configured to communicate with the third party. Such a third party is usually called a “merchant processor” or an “acquiring processor.”

Using payment card system payment network 128, the computers of acquirer 126 or the merchant processor will communicate with the computers of issuer processor 130, to determine whether the cardholder's account 132 is in good standing and whether the purchase is covered by the cardholder's available credit line or account balance. Based on these determinations, the request for authorization will be declined (“denied”) or accepted. If the request is accepted, an authorization code is issued to merchant 124.

When a request for authorization is accepted, the available credit line or available balance of cardholder's account 132 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 124 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer processor, the cardholder's account 132 is decreased. Normally, a charge is posted immediately to cardholder's account 132. The bankcard association then transmits the approval to the acquiring processor for distribution of goods/services, or information or cash in the case of an ATM.

After a transaction is captured, the transaction is settled between merchant 124, acquirer 126, and issuer processor 130. Settlement refers to the transfer of financial data or funds between the merchant's account, acquirer 126, and issuer processor 130 related to the transaction. Usually, transactions are captured and accumulated into a “batch,” which is settled as a group.

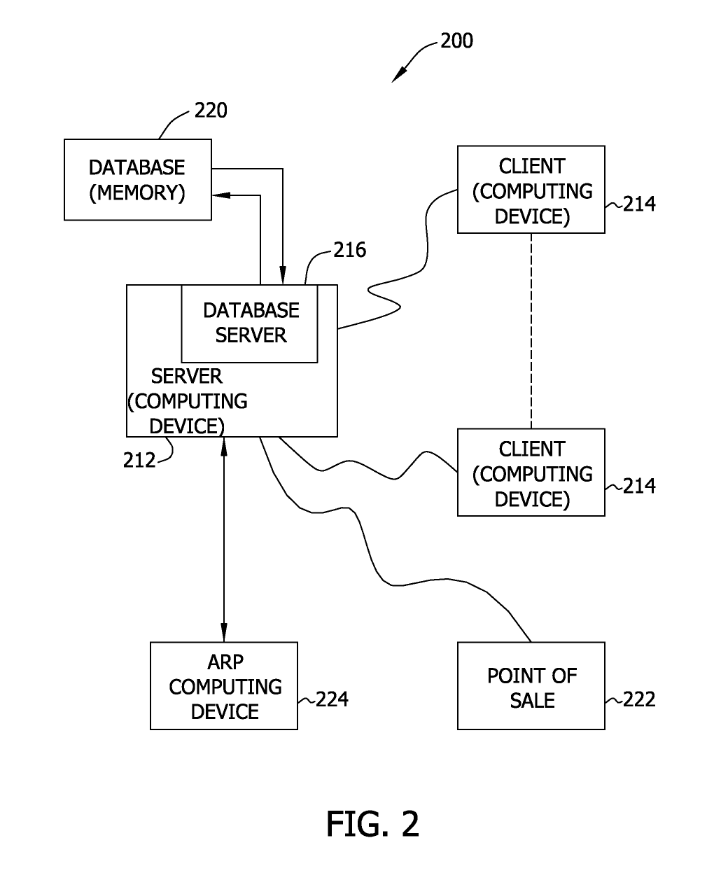

FIG. 2 is a simplified block diagram of an example aggregate rewards program system 200 that includes an aggregate rewards program (ARP) computing device 224 for aggregating consumer activity in a rewards program in accordance with one embodiment of the present disclosure. More specifically, ARP system 200 includes a server system 212 communicatively coupled to a plurality of client systems 214, also known as client computing devices.

In the example embodiment, client systems 214 are computers that include a web browser, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, or other web-based connectable equipment.

A database server 216 is communicatively coupled to a database 220 that stores data. In one embodiment, database 220 includes offer, registration, and activity data. In the example embodiment, database 220 is stored remotely from server system 212. In some embodiments, database 220 is decentralized. In the example embodiment, a person can access database 220 via client systems 214 by logging onto server system 212, as described herein.

An ARP computing device 224 is communicatively coupled with the server system 212. In the example embodiment, the server system 212 is configured to receive and process payment transactions initiated using a payment card. The ARP computing device 224 can access the server system 212 to store and access data and to communicate with the client systems 214 through the server system 212. In some embodiments, the ARP computing device 224 is associated with payment card system 120, shown in FIG. 1. In other embodiments, the ARP computing device 224 is associated with a third party and is merely in communication with the payment card system 120. The server system 212 may transmit data regarding approved payment transactions to the ARP computing device 224 individually or in batches.

One or more point of sale systems 222 are communicatively coupled with the server system 212. The one or more point of sale systems 222 can be merchants 124 shown in FIG. 1, where the point of sale systems 222 are communicatively coupled with the sever system through the payment card system 120. Point of sale systems 222 could be, but are not limited to, machines that accept card swipes, online payment portals, or stored payment card numbers for recurring transactions.

In some embodiments, server system 212 may be associated with a payment processing network, and may be referred to as an interchange computer system or an interchange network. Server system 212 may be used for processing transaction data and for registering cardholders and/or merchants into a plurality of programs offered by the interchange network, including, but not limited to, a rewards program. In addition, at least one of point of sale systems 222 may include a computer system associated with an issuer of a transaction card. Accordingly, server system 212 and point of sale systems 222 may be utilized to process transaction data relating to purchases a cardholder makes utilizing a transaction card processed by the interchange network and issued by the associated issuer. At least one client system 214 may be associated with a user or a cardholder seeking to register, access information, or process a transaction with at least one of the interchange network, the issuer, or the merchant.

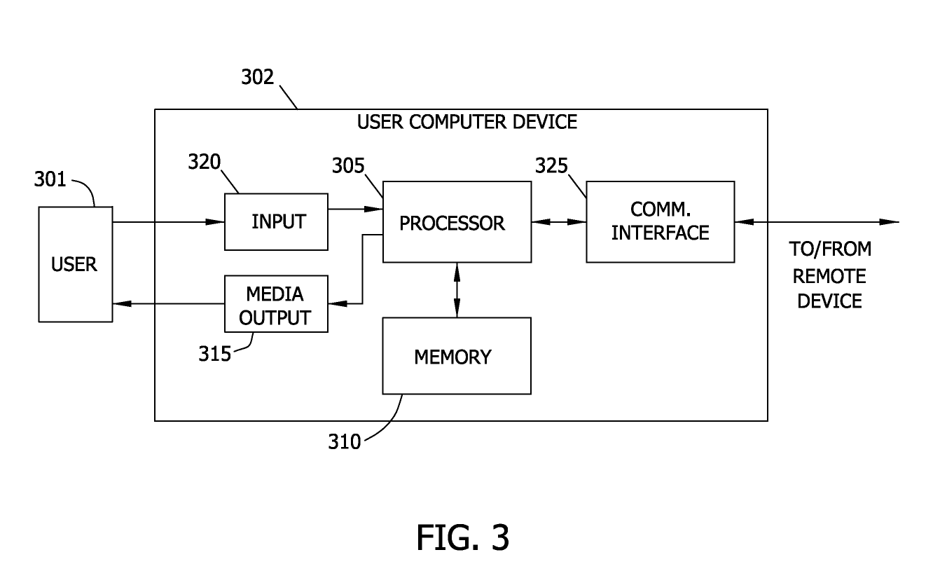

FIG. 3 illustrates an example configuration of a client system 214 shown in FIG. 2, in accordance with one embodiment of the present disclosure. User computer device 302 is operated by a user 301. User computer device 302 may include, but is not limited to, client systems 214 (shown in FIG. 2). User computer device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or transaction data to be stored and retrieved. Memory area 310 may include one or more computer readable media.

User computer device 302 also includes at least one media output component 315 for presenting information to user 301. Media output component 315 is any component capable of conveying information to user 301. In some embodiments, media output component 315 includes an output adapter (not shown) such as a video adapter and/or an audio adapter. An output adapter is operatively coupled to processor 305 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computer device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computer device 302 may also include a communication interface 325, communicatively coupled to a remote device such as server system 212 (shown in FIG. 2). Communication interface 325 may include, for example, a wired or wireless network adapter and/or a wireless data transceiver for use with a mobile telecommunications network.

Stored in memory area 310 are, for example, computer readable instructions for providing a user interface to user 301 via media output component 315 and, optionally, receiving and processing input from input device 320. A user interface may include, among other possibilities, a web browser and/or a client application. Web browsers enable users, such as user 301, to display and interact with media and other information typically embedded on a web page or a website from server system 212. A client application allows user 301 to interact with, for example, server system 212. For example, instructions may be stored by a cloud service, and the output of the execution of the instructions sent to the media output component 315.

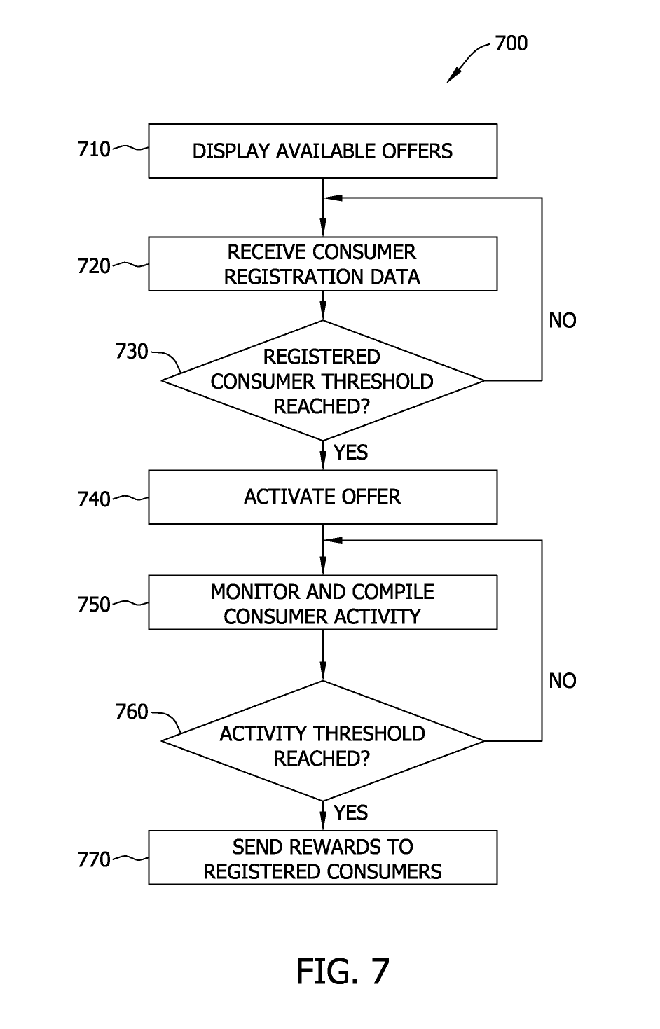

Processor 305 executes computer-executable instructions for implementing aspects of the disclosure. In some embodiments, the processor 305 is transformed into a special purpose microprocessor by executing computer-executable instructions or by otherwise being programmed. For example, the processor 305 can be programmed with the instruction such as illustrated in FIG. 7.

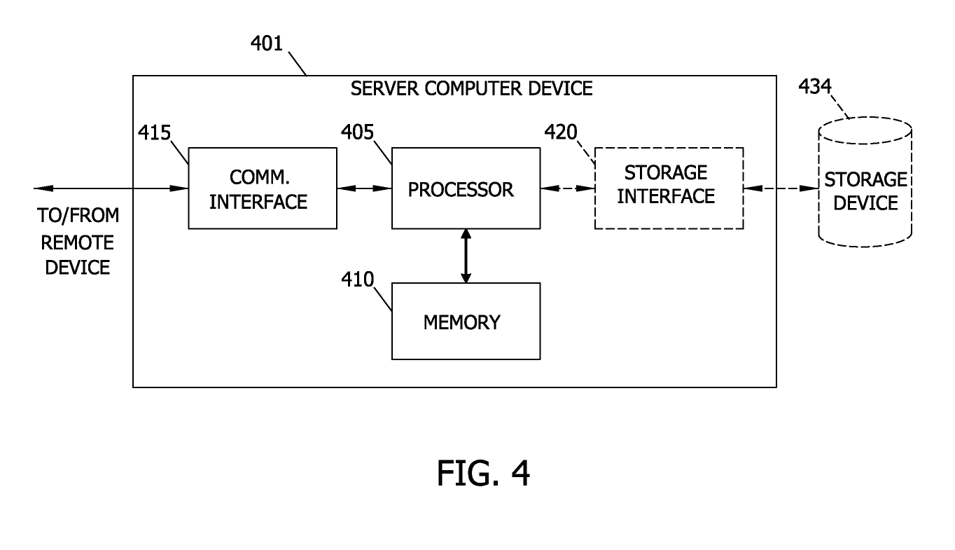

FIG. 4 illustrates an example configuration of the server system 212 shown in FIG. 2, in accordance with one embodiment of the present disclosure. Server computer device 401 may include, but is not limited to, database server 216 (shown in FIG. 2). Server computer device 401 also includes a processor 405 for executing instructions. Instructions may be stored in a memory area 410. Processor 405 may include one or more processing units (e.g., in a multi-core configuration).

Processor 405 is operatively coupled to a communication interface 415 such that server computer device 401 is capable of communicating with a remote device such as client systems 214 or another server computer device 401. For example, communication interface 415 may receive requests from client systems 214 via the Internet, as illustrated in FIG. 2.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computer device 401. For example, server computer device 401 may include one or more hard disk drives as storage device 434. In other embodiments, storage device 434 is external to server computer device 401 and may be accessed by a plurality of server computer devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

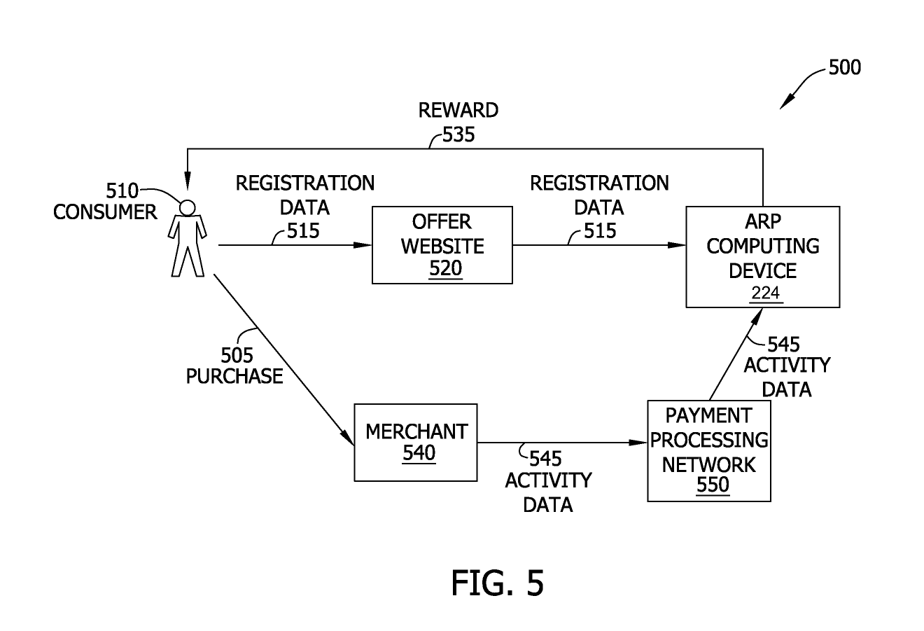

FIG. 5 is a block diagram illustrating an example of a rewards program 500 registering a consumer, monitoring a consumer's activity, and sending rewards to a consumer using the ARP computing device 224 (shown in FIG. 2). The ARP computing device 224 is configured to cause an offer website 520, which may be stored in the database 220 (shown in FIG. 2), to display to a consumer 510 through a client system 214 (shown in FIG. 2). The offer website 520, which is associated with a rewards program for a payment card, displays one or more reward offers to a plurality of consumers 510. The offer website 520 receives registration data 515 that the consumer 510 sent from the consumer's client system 214, and provides the registration data 515 to the ARP computing device 224, which stores the registration data 515 in the database 220. The registration data 515 contains the information required to identify the consumer 510 by the ARP computing device 224, for example the consumer's name, e-mail address, screen name, and a unique identifier such as the consumer's payment card number. The consumer 510 may also register for the reward offer through the mail, a sign-up form, via the telephone, or any other method that will allow for the transfer of registration data 515 and a user may enter the registration data into the ARP computing device 224. While the consumer may register for more than one reward offer at a time, the consumer may only be registered for one active reward offer at a time.

The ARP computing device 224 counts the number of consumers 510 that have registered for the reward offer. The ARP computing device 224 compares the number of registered consumers against a registered consumer threshold contained in the reward offer (i.e., a predetermined minimum number of registered consumers). When the registered consumer threshold is reached, the ARP computing device 224 activates the reward offer. In this embodiment when the ARP computing device 224 activates the reward offer, no additional consumers 510 may register for that reward offer. If a consumer 510 attempts to register for a reward offer after the reward offer has activated, the ARP computing device 224 may guide the consumer 510 to similar reward offers that are still allowing consumer registration. In some embodiments, if a consumer later leaves an active reward offer, another user may enter the reward offer from a waiting list or the like.

While the reward offer is active, the ARP computing device 224 monitors the payment transactions of each of the consumers 510 that have registered for the reward offer. To monitor the payment transactions of the registered consumers the APR computing device 224 provides the server system 212 with a list of the registered consumers 510 that are associated with active reward offers and receives from the server system 212 every payment transaction, or a small subset of payment transactions, initiated by each registered consumer's payment card. Similar to the process described in FIG. 1, the registered consumer 510, who may be a cardholder 122, tenders payment for a purchase 505 from a merchant 540, which may be similar to merchant 124, with a payment account card. For example, tendering of payment may be done at a point of sale terminal 222. The merchant 540 sends a request for authorization that contains activity data 545 of the transaction to the payment processing network 550, which may be the payment card system 120. After the request for authorization is approved, the payment processing network 550 checks to see if the consumer 510 is participating in an active reward offer. If the result is yes, then the payment processing network 550 transmits the activity data 545 of the transaction to the ARP computing device 224. The activity data 545 contains information such as a cardholder ID and a transaction amount. As mentioned above, the ARP computing device 224 could be a part of the approval process shown in FIG. 1 or it could be associated with a third party and receive the activity data 545 sometime after the transaction is complete. The ARP computing device 224 may be configured to receive the activity data 545 individually or in batches (i.e., once a day).

The ARP computing device 224 compiles the activity data 545 from the consumers 510 that registered for the reward offer. When the ARP computing device 224 has determined that the combined total amount of activity has reached an activity threshold (e.g., total number of transactions or total dollars spent), the ARP computing device 224 deactivates the reward offer and stops monitoring the payment transactions of the registered consumers 510. After the reward offer is deactivated, the ARP computing device 224 sends a reward 535 to the registered consumers 510 against the deactivated reward offer. In some embodiments, the ARP computing device 224 continues to monitor payment transaction activity for consumers in one or more additional rewards programs. In this embodiment, the ARP computing device 224 sends the registered consumer 510 the reward 535 via a redemption code which the ARP computing device 224 sends to the registered consumer's e-mail. In other embodiments, the reward 535 can be sent, for example, via an electronic message, a text message to the consumer's smart phone, Short Message Service (SMS), an app to display the redemption code, or through a physical mailing. In this embodiment, once the reward offers are sent to the registered consumers 510, the reward offer is finished and the ARP computing device 224 allows the registered consumers 510 to register for a different reward offer.

In some embodiments, a consumer's payment transaction activity must exceed, or meet, an activity qualification threshold (e.g., be above a certain dollar amount) to be a qualifying activity and counted against the activity threshold. In other embodiments, to qualify for the basic reward, the ARP computing device 224 determines if the registered consumer 510 has performed enough qualifying activities to meet a minimum activity threshold while the reward offer was active (e.g., 5 or more transactions).

In another embodiment, the rewards program 500 is linked to one or more charities. For every qualifying activity that a registered consumer 510 performs while the reward offer is active, the ARP computing device 224 sends a donation to one or more charities. In some embodiments, as part of the registration process, the offer website 520 enables the consumer 510 to select one or more charities to receive the donations.

In a further embodiment, the ARP computing device 224 determines the registered consumer's preferences based on his or her participation in one or more reward offers. For example, the ARP computing device 224 may determine that the consumer 510 likes to travel based upon enrollment in a vacation reward program, that the consumer 510 is a fan of Mexican food based on the consumer 510 enrolling in multiple restaurant reward programs, or that the consumer 510 registers for a home improvement reward program every spring. Based on that determination, the ARP computing device 224 can suggest additional reward offers to the registered consumer 510 that he or she may want to participate in.

In some situations, the registered consumer 510 may receive a reward that is no longer needed or desired. For example, a consumer 510 may have signed up for a rewards program that offered a gift card from a home improvement center. However, due to a change in the consumer's circumstances, the gift card from the home improvement center is no longer desired because the home improvement was finished before the reward was received by the consumer 510. To account for such scenarios, the offer website 520 may also contain a trading section that enables registered consumers 510 to exchange unused rewards. The trading section is configured to enable a registered consumer 510 to trade unwanted rewards with other consumers 510 for another reward offer that a different registered consumer 510 does not want. For example, a first registered consumer with a home improvement gift card could trade the home improvement gift card to a second registered consumer for a restaurant gift card that the second registered consumer does not want.

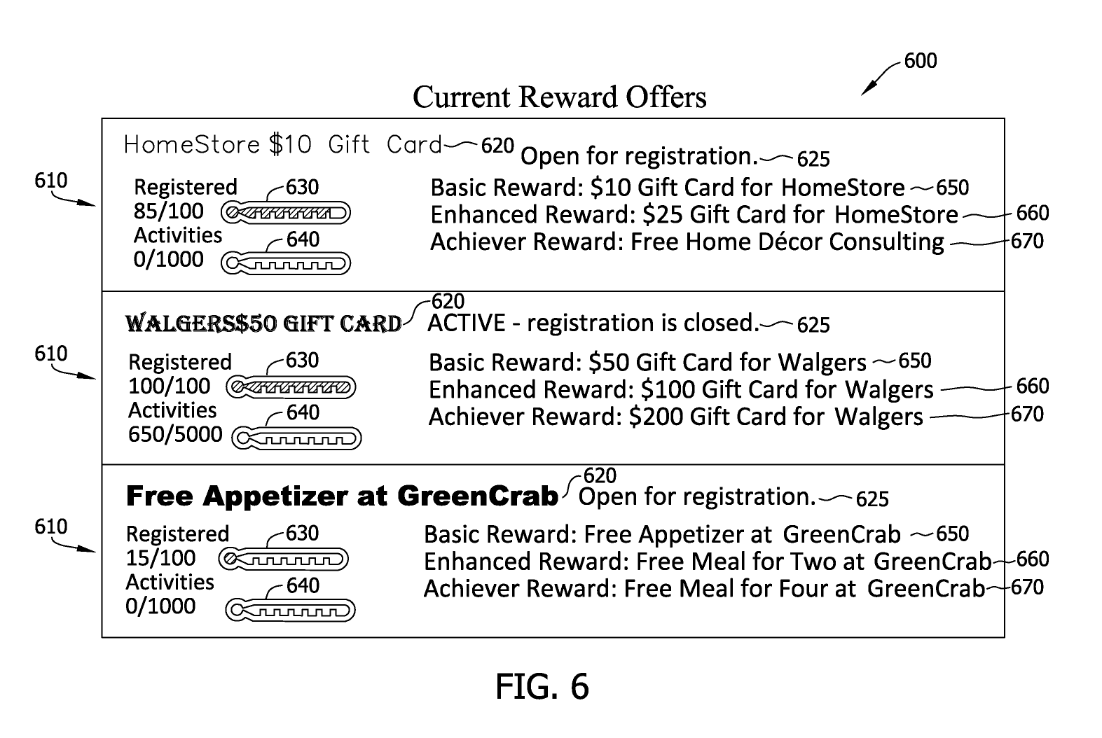

FIG. 6 is a diagram of an example user interface 600 for enabling a consumer 510 to select a reward offer 610 from a plurality of reward offers and displaying a status 625 of reward offers, in accordance with one embodiment of the present disclosure. ARP computing device 224 may transmit instructions and data to client system 214 of the consumer 510 for displaying user interface 600. The user interface 600 includes one or more open reward offers 610. If one of the reward offers is selected by the consumer 510, ARP computing device 224 receives a notification of which offer the consumer 510 selected from client system 214 and transmits instructions and data to display a registration form (not shown) on client system 214. The registration form is configured to receive registration data 515 from the consumer 510. If the consumer 510 fills out and submits the form, ARP computing device 224 receives registration data 515. The registration data 515 contains the information required to identify the consumer 510 by the ARP computing device 224, for example the consumer's name, e-mail address, screen name, and a unique identifier such as the consumer's payment card number.

The ARP computing device 224, through the client system 214, displays a title 620 to identify the reward offer 610, a registered consumer display 630, which may show a current number of registered consumers and a maximum number of registered consumers, and an activity display 640, which shows both a current number of qualifying activities performed and an activity threshold which needs to be met for the rewards to be sent out. In some embodiments, the maximum number of registered consumers could be a registered consumer threshold for the ARP computing device 224 to activate the reward offer 610. In some embodiments, once the reward offer 610 is active no additional consumers 510 may register for the reward offer 610 (i.e., the reward offer 610 is considered full). If a consumer 510 attempts to register for an active reward offer 610, the ARP computing device 224 would indicate that the desired rewards program is full, and provides the consumer 510 with a list of one or more similar reward offers 610 that open for registration. In some further embodiments, once a consumer 510 registers for a reward offer 610, the consumer 510 may not leave the reward offer 610 or register for other reward offers 610 until the reward offer 610 is finished.

In the exemplary embodiment, each reward offer 610 contains multiple types of rewards. The first type is a basic reward 650, which the ARP computing device 224 will send to all of the consumers 510 that registered for the reward offer 610 and performed the minimum number of qualifying instructions. The second type is an enhanced reward 660. The ARP computing device 224 is configured to randomly select a number of registered consumers 510, who performed the minimum number of qualifying transactions, to send the enhanced reward 660. The third type of reward is an achievement reward 670. The ARP computing device 224 will calculate which registered consumer 510 had the most activity (e.g., most qualifying transactions, most dollars spent, etc.) while the reward offer 610 was active and send the achievement reward 670 to the registered consumer 510 with the most activity. In one embodiment, the activity is a number of qualifying transactions. However, in other embodiments, the activity could be dollars spent or number of nights stayed for example.

FIG. 7 is a flowchart illustrating an example of the process of aggregating consumer activity in a rewards program 700 using the system shown in FIG. 2, in accordance with one embodiment of the present disclosure. Process 700 may be implemented by a computing device, for example the ARP computing device 224. The ARP computing device 224 causes the client system 214 to display 710 one or more reward offers 610 available to consumers 510, for example through the offer website 520. Then the ARP computing device 224 receives 720 the consumer's registration data 515 from a client system 214. The ARP computing device 224 continues to receive 720 registration data 515 for additional consumers 510 and determines if the registered consumer threshold has been reached 730. When the registered consumer threshold is reached 730, the ARP computing device 224 activates 740 the reward offer 610. Next the ARP computing device 224 communicates with the payment processing network 550 to monitor and compile 750 the qualifying activities from all of the registered consumers 510. The ARP computing device 224 repeatedly checks the total number of qualifying activities to see if the total number reaches 760 the activity threshold. If the activity threshold is reached 760, then the ARP computing device 224 sends 770 out, or authorizes the sending of, the basic reward 650 to the registered consumers 510 and the reward offer 610 is finished.

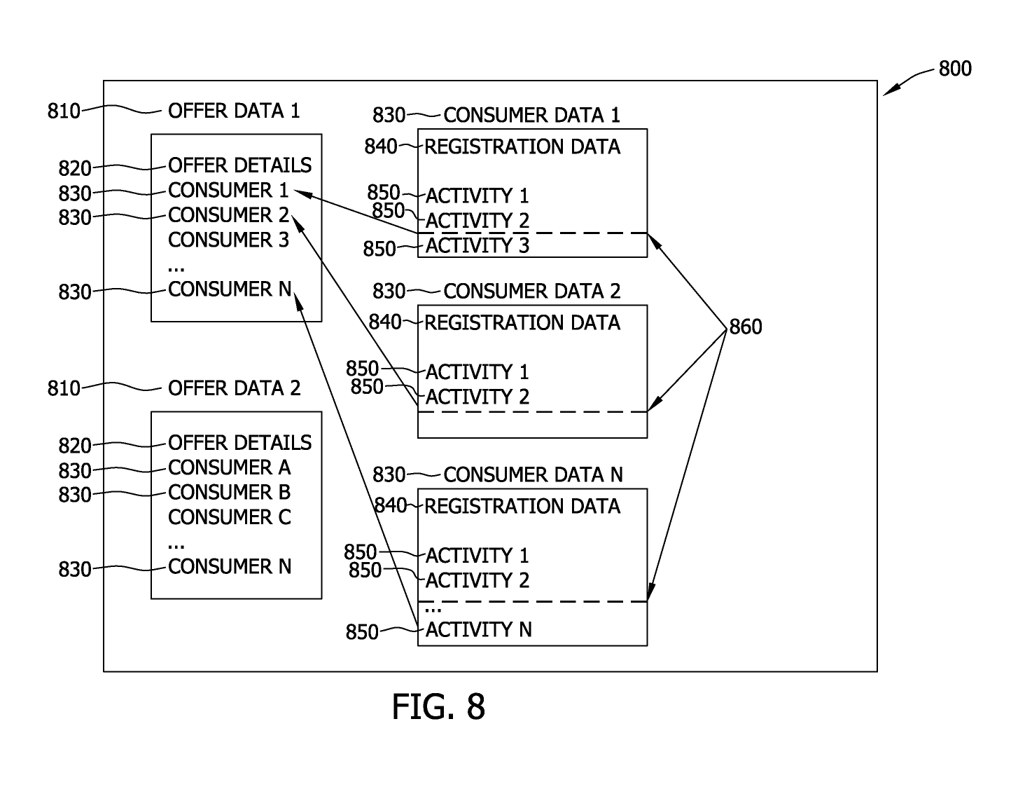

FIG. 8 is a diagram of the components of an example database 800 included in the ARP system 200 shown in FIG. 2, in accordance with one embodiment of the present disclosure. The database 800 is similar to database 220. In this embodiment, the database 800 contains one or more offer data 810. Each offer data 810 contains offer details 820, which may include one or more details of the title 620, the basic reward 650, the enhanced reward 660, the achievement award 670, the activity qualification threshold, a minimum activity threshold 860, and the activity threshold. Each offer data 810 may also include one or more consumer data 830 associated with one or more consumers 510 that have registered for the reward offer 610. Each consumer data 830 includes a registration data 840 and possibly one or more qualifying activities 850 that the consumer 510 performed while the reward offer 610 was active.

In this embodiment, when the consumer 510 registers for the reward offer 610, the ARP computing device 224 instructs the database 800 to store the registration data 840 in connection with the consumer data 830 and the offer data 810 for the reward offer 610 that the consumer 510 registered for. After the ARP computing device 224 activates the reward offer 610, the ARP computing device 224 counts each activity 850 of the consumer 510 and attaches those activities to the consumer data 830. In this embodiment, attaching the activities 850 to the consumer data 830 enables the ARP computing device 224 to measure the activities of each consumer 510 to determine whether the minimum activity threshold 860 has been reached by a particular consumer 510, as shown in FIG. 8. Attaching the activities 850 may also enables the ARP computing device 224 to measure the activities of each consumer 510 to determine which consumer 510 has the most activities and will receive the achievement award.

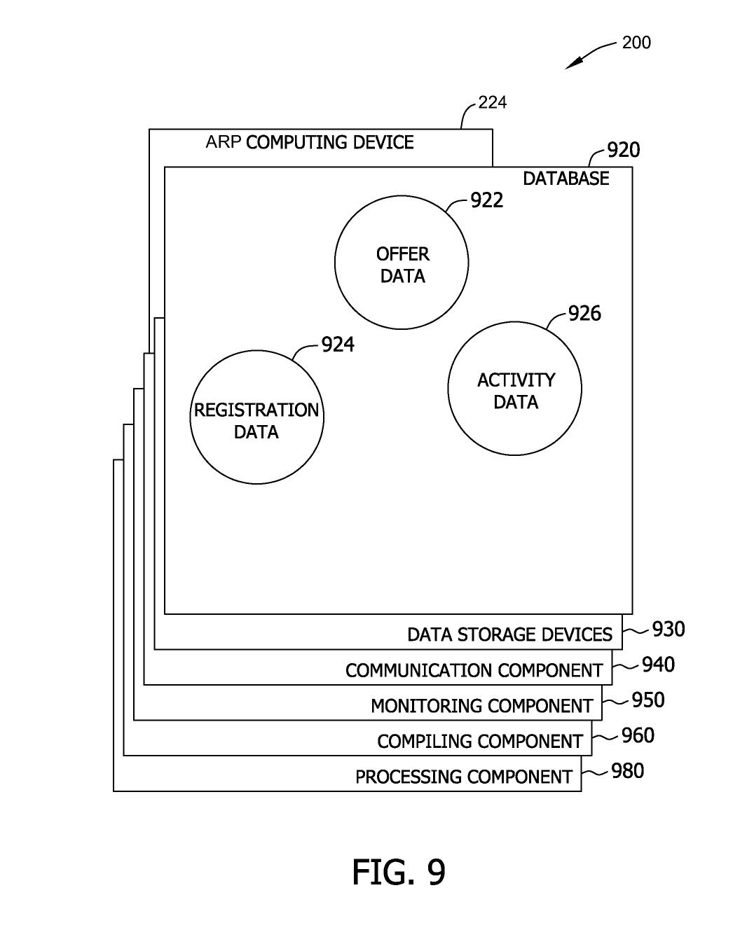

FIG. 9 is an example configuration of the ARP computing device 224 within the aggregate rewards program system 200 shown in FIG. 2, in accordance with one embodiment of the present disclosure. Database 920 may be coupled with several separate components within computing device 910, which perform specific tasks.

In this embodiment, database 920 includes offer data 922, registration data 924 and activity data 926. In some embodiments, database 920 is similar to database 220 (shown in FIG. 2), offer data 922 is similar to reward offer 610 (shown in FIG. 6), registration data 924 is similar to registration data 515 (shown in FIG. 5), and activity data 926 is similar to activity data 545 (shown in FIG. 5).

ARP computing device 224 includes the database 920, as well as data storage devices 930. ARP computing device 224 also includes a communication component 940 for receiving registration data 924 for the database 920 and sending the reward 535 from the database 920 to client systems 214 (shown in FIG. 2). ARP computing device 224 also includes a monitoring component 950 for monitoring the activity of the registered consumers 510. A compiling component 960 is also included for compiling the total amount of activity completed by the registered consumers 510 from the activity data 926. A processing component 980 assists with execution of computer-executable instructions associated with the rewards program system.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for aggregating consumer activity in a loyalty reward program, said method implemented using a computing device in communication with a memory, said method comprising:
storing, in the memory, at least one reward offer containing a reward and an activity threshold;
receiving registration data from a plurality of registered consumers for the at least one reward offer;
storing, in the memory, the registration data for each of the plurality of registered consumers;
monitoring financial transaction data for at least one qualifying activity completed by at least one of the plurality of registered consumers;
compiling, by the computing device, a total number of qualifying activities completed by all of the registered consumers; and
sending the reward to each of the registered consumers when the activity threshold is reached by the total number of qualifying activities.

2. The method in accordance with claim 1 further comprising activating the reward offer when a registered consumer threshold is reached.

3. The method in accordance with claim 1 further comprising sending an enhanced reward to a predetermined number of randomly selected ones of the registered consumers.

4. The method in accordance with claim 1 further comprising sending an achievement reward to a registered consumer with the highest number of qualifying activities.

5. The method in accordance with claim 1, wherein receiving registration data further comprises storing a charitable organization chosen by the registered consumer.

6. The method in accordance with claim 1 further comprising sending a donation to a charitable organization for each qualifying activity.

7. The method in accordance with claim 1 further comprising selecting registered consumers with a minimum amount of qualifying activities to receive the reward.

8. A computing device for aggregating consumer activity in a loyalty reward program, said computing device comprising a processor communicatively coupled to a memory device, said computing device configured to:
store at least one reward offer containing a reward and an activity threshold;
receive registration data from a plurality of registered consumers for the at least one reward offer;
store the registration data for each of the plurality of registered consumers;
monitor at least one qualifying activity completed by at least one of the plurality of registered consumers;
compile a total number of qualifying activities completed by all of the registered consumers; and
send the reward to each of the registered consumers when the activity threshold is reached by the total number of qualifying activities.

9. The computing device of claim 8 further configured to activate the reward offer when a registered consumer threshold is reached.

10. The computing device of claim 8 further configured to send an enhanced reward to a predetermined number of randomly selected registered consumers.

11. The computing device of claim 8 further configured to send an achievement reward to a registered consumer with the highest number of qualifying activities.

12. The computing device of claim 8, wherein registration data includes a charitable organization chosen by the registered consumer in the registration data.

13. The computing device of claim 8 further configured to send a donation to a charitable organization for each qualifying activity.

14. The computing device of claim 8 further configured to select registered consumers with a minimum amount of qualifying activities to receive the reward.

15. A computer-readable storage medium having computer-executable instructions embodied thereon, wherein when executed by a computing device having at least one processor coupled to a memory device, the computer-executable instructions cause the processor to:
store at least one reward offer containing a reward and an activity threshold;
receive registration data from a plurality of registered consumers for the at least reward one offer;
store the registration data for each of the plurality of registered consumers;
monitor at least one qualifying activity completed by at least one of the plurality of registered consumers;
compile a total number of qualifying activities completed by all of the registered consumers; and
send the reward to each of the registered consumers when the activity threshold is reached by the total number of qualifying activities.

16. The computer-readable storage medium of claim 15, wherein the computer-executable instructions further cause the processor to activate the reward offer when a registered consumer threshold is reached.

17. The computer-readable storage medium of claim 15, wherein the computer-executable instructions further cause the processor to send an enhanced reward to a predetermined number of randomly selected registered consumers.

18. The computer-readable storage medium of claim 15, wherein the computer-executable instructions further cause the processor to send an achievement reward to the registered consumer with the highest number of qualifying activities.

19. The computer-readable storage medium of claim 15, wherein the computer-executable instructions further cause the processor to send a donation to a charitable organization for each qualifying activity.

20. The computer-readable storage medium of claim 15, wherein the computer-executable instructions further cause the processor to select registered consumers with a minimum amount of qualifying activities to receive the reward.
